(19) United States
(12) Patent Application Publication
(10) Pub. No.: US 2025/0289249 A1
(43) Pub. Date: Sep. 18, 2025

(54) THERMAL PRINTER

(71) Applicant: Seiko Instruments Inc., Chiba-shi (JP)

(72) Inventor: Tomohiro MURATA, Chiba-shi (JP)

(21) Appl. No.: 19/077,330

(22) Filed: Mar. 12, 2025

(30) Foreign Application Priority Data
Mar. 15, 2024 (JP) 2024-041375

(51) Int. Cl. B41J 13/10; B41J 2/32; B41J 11/04; B41J 13/03

(52) U.S. Cl. CPC B41J 13/103; B41J 2/32; B41J 11/04; B41J 13/03

(57) ABSTRACT

A thermal printer includes: a housing; a platen roller supported on the housing so as to be rotatable; a thermal head housed in the housing and arranged so as to be opposed to the platen roller; and a paper guide that forms a sheet passage for a sheet between the housing and the paper guide, and is pivotally supported on the housing so as to be pivotable about a pivot axis between a guide position at which the sheet is allowed to be fed between the platen roller and the thermal head, and an open position at which the sheet passage for the sheet is exposed.

### RELATED APPLICATIONS

This application claims priority to Japanese Patent application No. JP2024-041375, filed on Mar. 15, 2024, the entire content of which is incorporated herein by reference.

### BACKGROUND OF THE INVENTION

### 1. Field of the Invention

The present invention relates to a thermal printer.

### 2. Description of the Related Art

Hitherto, there has been known a thermal printer including a printing unit, which is configured by a thermal head and a platen roller arranged so as to be opposed to the thermal head. There have been known thermal printers of a so-called clamshell type and a so-called autoloading type. In a thermal printer of the clamshell type, the thermal head and the platen roller are spaced apart from each other before a sheet to be fed is set during non-printing, and the thermal head and the platen roller are brought into contact with each other after the sheet is fed, to perform printing. In a thermal printer of the autoloading type, a distance between the thermal head and the platen roller is fixed, and the sheet is inserted between the thermal head and the platen roller, to perform printing. In particular, as a method suitable for printing sheets such as labels each having a leading edge of a print area that is clearly defined, various technologies have been proposed for the thermal printer of the autoloading type.

For example, in Japanese Patent Application Laid-open No. 2009-119733 A, the following thermal printer is disclosed. The thermal printer includes a thermal printer and a platen roller that are arranged so as to be opposed to each other through a minute gap, and has a configuration in which a gap dimension between the thermal printer and the platen roller during non-printing is set smaller than a thickness dimension of a sheet to be fed for printing.

According to the technology described in Japanese Patent Application Laid-open No. 2009-119733 A, a sheet is inserted between the thermal printer and the platen roller, which are opposed to each other through such a minute gap, to perform printing. Thus, it is said that, as compared to a case in which the thermal printer and the platen roller are always held in contact with each other, formation of pressure contact marks on the platen roller can be suppressed, and print quality can be improved. Further, the gap dimension between the thermal printer and the platen roller is smaller than the thickness dimension of the sheet. Thus, it is said that printing can be performed without forming a margin on a leading edge side of the sheet in a conveying direction.

However, in the related art described above, when a paper jam occurs on a sheet passage from a sheet feed port to the platen roller or when scraps of the sheet or other foreign matters accumulate, there has been a risk that it is difficult to remove these foreign matters. Further, for example, when a paper guide that forms the sheet passage is formed to be separable in order to enable maintenance, it is required to provide a separate fixing part, which may increase the number of parts. In addition, when the paper guide is misaligned before and after performing maintenance, printing accuracy may be affected.

Accordingly, in the related art, particularly in the thermal printer of the autoloading type, there has been a problem in improving maintainability while suppressing an increase in the number of parts and a reduction in printing accuracy.

In view of such a problem, the present invention has an object to provide a thermal printer that enables maintenance to be performed easily while suppressing an increase in the number of parts and a reduction in printing accuracy.

### SUMMARY OF THE INVENTION

According to one embodiment of the present invention, there is provided a thermal printer including: a housing; a platen roller supported on the housing so as to be rotatable; a thermal head housed in the housing and arranged so as to be opposed to the platen roller; and a paper guide that forms a sheet passage for a sheet between the housing and the paper guide, and is pivotally supported on the housing so as to be pivotable about a pivot axis between a guide position at which the sheet is allowed to be fed between the platen roller and the thermal head, and an open position at which the sheet passage for the sheet is exposed.

In the above-mentioned thermal printer according to the one embodiment of the present invention, wherein the pivot axis is coaxial with a platen shaft of the platen roller.

In the above-mentioned thermal printer according to the one embodiment of the present invention, wherein the paper guide includes a snap-fit portion that is fixed to the housing in the guide position.

In the above-mentioned thermal printer according to the one embodiment of the present invention, wherein the paper guide includes a guide roller configured to feed the sheet between the platen roller and the thermal head.

### BRIEF DESCRIPTION OF THE DRAWINGS

FIG. 1 is a perspective view for illustrating a state in which a paper guide is at a guide position in a thermal printer according to an embodiment.

FIG. 2 is a perspective view for illustrating a state in which the paper guide is at an open position in the thermal printer according to the embodiment.

FIG. 3 is a back perspective view for illustrating a state in which the paper guide is at the guide position in the thermal printer according to the embodiment.

FIG. 4 is a back perspective view for illustrating a state in which the paper guide is at the open position in the thermal printer according to the embodiment.

FIG. 5 is a sectional view taken along the line V-V of FIG. 3.

FIG. 6 is a sectional view taken along the line VI-VI of FIG. 4.

FIG. 7 is a perspective view for illustrating a state in which a platen roller and the paper guide are mounted.

FIG. 8 is a sectional view for illustrating a configuration of a snap-fit portion as seen from a front side in a direction of conveying a sheet.

### DETAILED DESCRIPTION OF THE PREFERRED EMBODIMENTS

Now, embodiments of the present invention are described with reference to the drawings. In the following description, components having the same or similar functions are denoted by the same reference symbols. Overlapping description of those components is omitted in some cases. In the drawings, FR, LH, and UP represent a front side, a left side, and an upper side of the thermal printer, respectively. The front side refers to a front side in a direction of conveying a sheet 10 to be fed to a thermal printer 1.

### Thermal Printer

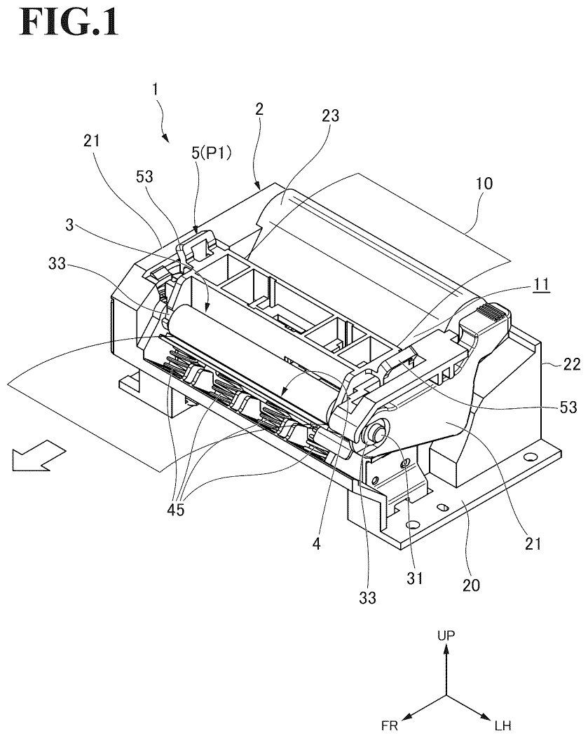

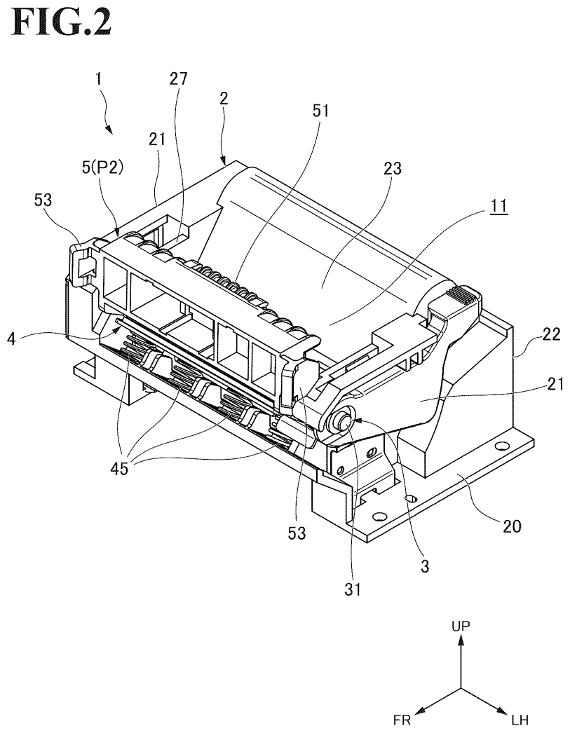

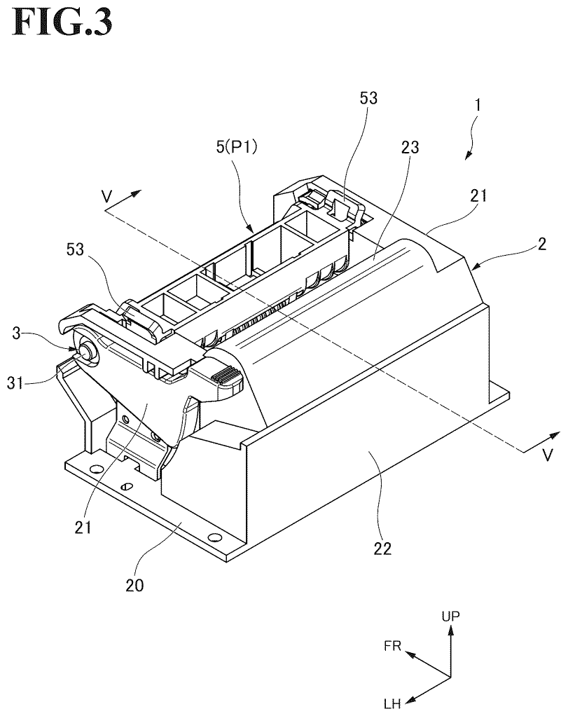

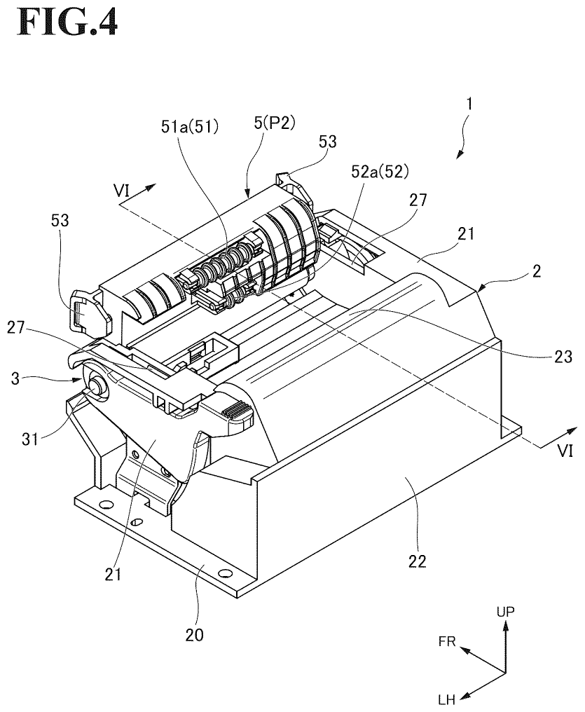

FIG. 1 is a perspective view for illustrating a state in which a paper guide 5 is at a guide position P1 in the thermal printer 1 according to the embodiment. FIG. 2 is a perspective view for illustrating a state in which the paper guide 5 is at an open position P2 in the thermal printer 1 according to the embodiment. FIG. 3 is a back perspective view for illustrating a state in which the paper guide 5 is at the guide position P1 in the thermal printer 1 according to the embodiment. FIG. 4 is a back perspective view for illustrating a state in which the paper guide 5 is at the open position P2 in the thermal printer 1 according to the embodiment.

The thermal printer 1 according to this embodiment is used while being placed on, for example, a desk or a floor. Accordingly, in this embodiment, a posture under a state in which the thermal printer 1 is placed on, for example, a desk or a floor as illustrated in FIG. 1 is described as an example. The thermal printer 1 may be carried by a user in use. In this case, the thermal printer may be used in such a posture that, for example, a front side in FIG. 1 is facing upward or downward.

As illustrated in FIG. 1 to FIG. 4, the thermal printer 1 includes a housing 2, a platen roller 3, a thermal head 4, and the paper guide 5.

The housing 2 includes a bottom wall 20, a pair of right and left side walls 21, a rear wall 22, and an upper wall 23, and is formed into a box shape with an opening in the upper front and the front of the housing. The housing 2 is made of a resin material such as polycarbonate or a metal material.

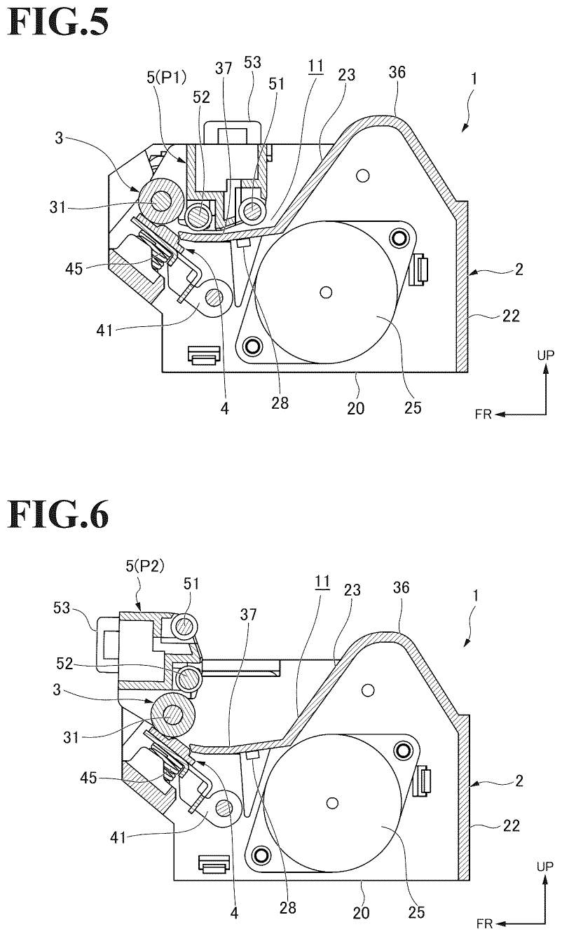

FIG. 5 is a sectional view taken along the line V-V of FIG. 3. FIG. 6 is a sectional view taken along the line VI-VI of FIG. 4.

As illustrated in FIG. 5 and FIG. 6, the upper wall 23 includes a protruding portion 36 and a forward extending portion 37. The protruding portion 36 protrudes from an upper end portion of the rear wall 22 so as to become convex upward as extending forward. The forward extending portion 37 extends forward from a front end portion of the protruding portion 36. The sheet 10 (see FIG. 1) to be fed for printing is conveyed along this upper wall 23. At a position in the upper wall 23 near the platen roller 3, there is provided a sensor 28 for detecting a position of a leading edge of the sheet 10 to be conveyed. In this embodiment, the sheet 10 to be fed for printing is heat-sensitive paper, such as various labels and stickers. A drive motor 25 is housed in a space enclosed by the rear wall 22, the bottom wall 20, and the upper wall 23.

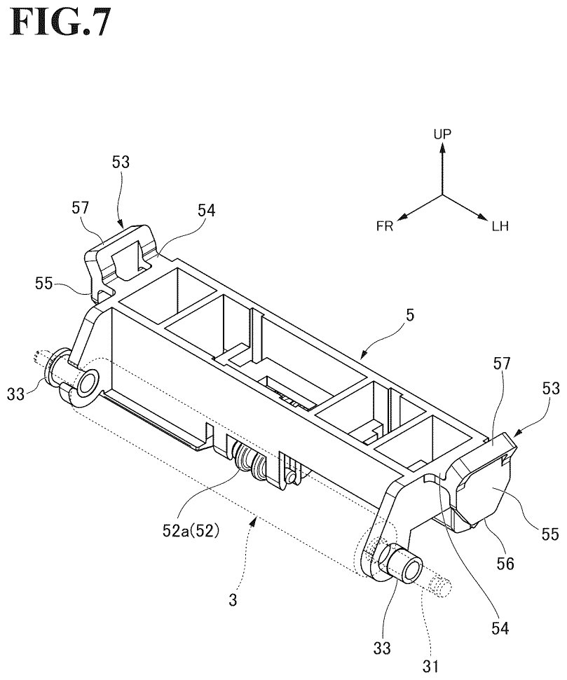

FIG. 7 is a perspective view for illustrating a state in which the platen roller 3 and the paper guide 5 are mounted.

As illustrated in FIG. 1 and FIG. 2, a platen shaft 31 of the platen roller 3 is suspended from upper front end portions of the pair of right and left side walls 21. The platen shaft 31 is fixed to the pair of right and left side walls 21, and extends along a right-and-left direction. As illustrated in FIG. 1, FIG. 2, and FIG. 7, the platen roller 3 is supported on an outer peripheral portion of the platen shaft 31 so as to be freely rotatable. The platen roller 3 is driven to rotate by transmission of a drive force from the drive motor 25.

As illustrated in, for example, FIG. 1 and FIG. 5, below the platen roller 3, the thermal head 4 of a line type is arranged so as to be opposed to and substantially parallel to the platen roller 3. In the thermal head 4, a plurality of heat-generating elements are arranged in alignment in the right-and-left direction on a metal substrate. As illustrated in FIG. 5, the thermal head 4 is mounted to a distal end portion (one end portion) of a bracket 41 having one end portion that is swingable with respect to the housing 2. The thermal head 4 is always urged toward the platen roller 3 side by urging members 45 provided between the thermal head 4 and the housing 2. Accordingly, during non-printing when the sheet 10 is not set, the platen roller 3 and the thermal head 4 are held in contact with each other. Further, during printing when the sheet 10 is set, the platen roller 3 and the thermal head 4 are held in press contact with each other through intermediation of the sheet 10.

As illustrated in FIG. 1 and FIG. 7, the paper guide 5 is provided in the upper front of the housing 2 and near the platen roller 3. The paper guide 5 is pivotally supported so as to be pivotable about the platen shaft 31 through bearings 33 provided on both of right and left sides of the platen shaft 31. As a result, the paper guide 5 is pivotally supported on the housing 2 so as to be pivotable about a pivot axis (that is, the platen shaft 31). In other words, the pivot axis of the paper guide 5 is coaxial with the platen shaft 31. It is preferred that the bearings 33 be configured so as to prevent the platen shaft 31 and the platen roller 3 from rotating when the paper guide 5 pivots.

The paper guide 5 can be pivoted between the guide position P1, which is mainly in a printing state illustrated in FIG. 1, FIG. 3, and FIG. 5, and the open position P2, which is mainly in a maintenance state illustrated in FIG. 2, FIG. 4, and FIG. 6. As illustrated in FIG. 5, a lower surface of the paper guide 5 in the guide position P1 is formed into a curved shape that is convex downward (see also FIG. 4).

As illustrated in FIG. 1 and FIG. 5, when the paper guide 5 is at the guide position P1, the paper guide 5 forms a sheet passage 11 for the sheet 10 between the paper guide 5 and the housing 2. Along the sheet passage 11, the sheet 10 inserted along the upper wall 23 from the rear side is guided into a space between the platen roller 3 and the thermal head 4. The sheet 10 is inserted between the platen roller 3 and the thermal head 4 through the sheet passage 11, and thus printing can be performed on the sheet 10.

Meanwhile, as illustrated especially in FIG. 2 and FIG. 6, a rear end portion of the paper guide 5 is lifted upward, and thus the paper guide 5 can be pivoted to the open position P2 where the rear end portion of the paper guide 5 is located above the guide position P1. The open position P2 is a position where the paper guide 5 is pivoted by approximately 90 degrees from the guide position P1. When the paper guide 5 is pivoted to the open position P2, the sheet passage 11 for the sheet 10 is exposed. Here, a state in which “the sheet passage 11 is exposed” means that, for example, the sheet passage 11 is exposed to the extent that an upstream side of the platen roller 3 in the conveying direction is visible when a user visually inspects the sheet passage 11 from above (see FIG. 4). Thus, when a paper jam occurs or when scraps of the sheet 10 or other foreign matters accumulate, it is possible to visually check for the foreign matters and quickly remove the foreign matters.

As illustrated in FIG. 4 and FIG. 5, the paper guide 5 includes a plurality of (two in this embodiment) guide rollers 51 and 52 that feed the sheet 10 between the platen roller 3 and the thermal head 4 in the guide position P1. In the guide position P1, the two guide rollers 51 and 52 are arranged on the rear side and the front side in the direction of conveying the sheet 10, respectively. The two guide rollers 51 and 52 are provided so as to be freely rotatable with respect to the paper guide 5. As illustrated in FIG. 5, the rear guide roller 51 is arranged at a rear end portion of a lower surface of the paper guide 5 in the guide position P1. As illustrated in FIG. 4, the rear guide roller 51 is arranged substantially in a center of the paper guide 5 in the right-and-left direction, and is formed to be shorter than a length of the paper guide 5 in the right-and-left direction.

As illustrated in FIG. 5, the front guide roller 52 is provided on the lower surface of the paper guide 5 in the guide position P1 and closer to the platen roller 3 than the rear guide roller 51. As illustrated in FIG. 4, the front guide roller 52 is arranged substantially in the center of the paper guide 5 in the right-and-left direction, and is formed to be even shorter than the length of the rear guide roller 51. On outer peripheral portions of the guide rollers 51 and 52, protrusions 51a and 52a are provided to allow the sheet 10 to be conveyed easily while suppressing the sheet 10 from sticking to the paper guide 5.

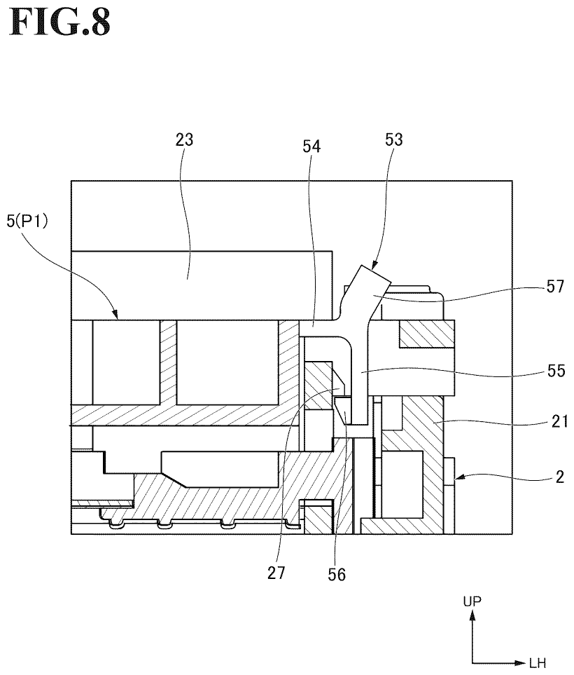

FIG. 8 is a sectional view for illustrating a configuration of a snap-fit portion 53 as seen from the front side in the direction of conveying the sheet 10.

As illustrated in FIG. 3, FIG. 4, and FIG. 8, the paper guide 5 includes a pair of snap-fit portions 53 at end portions thereof in the right-and-left direction. The right and left snap-fit portions 53 are symmetrically shaped, and hence the left snap-fit portion 53 is described below as an example. As illustrated in FIG. 8, the snap-fit portion 53 includes a coupling portion 54 connected to a main body of the paper guide, an extended portion 55 extending from the coupling portion 54 toward the lower surface of the paper guide 5, a locking claw 56 provided at a distal end of the extended portion 55, and a gripping portion 57 provided at a proximal end portion of the extended portion 55.

Further, a locking portion 27 is formed in each of the pair of side walls 21 of the housing 2 at a position corresponding to the snap-fit portion 53. The locking portion 27 is, for example, a hole into which the extended portion 55 of the snap-fit portion 53 is inserted and into which the locking claw 56 is engaged in the guide position P1. Accordingly, when the paper guide 5 is pivoted from the open position P2 to the guide position P1, the snap-fit portion 53 is locked to the locking portion 27, thereby fixing the paper guide 5 to the housing 2. Further, when the engaging state is canceled, by pressing the gripping portion 57 inward in the right-and-left direction, the engagement of the locking claw 56 is canceled, and thus the paper guide 5 can be pivoted.

### Operations and Effects

Next, operations and effects of the above-mentioned thermal printer 1 are described.

According to the thermal printer 1 of this embodiment, the thermal printer 1 includes the housing 2, the platen roller 3, the thermal head 4, and the paper guide 5. The paper guide 5 is pivotally supported on the housing 2 so as to be pivotable about the pivot axis between the guide position P1 and the open position P2. According to this configuration, when the paper guide 5 is at the guide position P1, the sheet passage 11 is formed between the housing 2 and the paper guide 5, and hence the sheet 10 can be fed between the platen roller 3 and the thermal head 4 through this sheet passage 11. The paper guide 5 is pivotally supported on the housing 2 so as to be pivotable between the guide position P1 and the open position P2. With this, for example, when a paper jam occurs, the sheet passage 11 is exposed by pivoting the paper guide 5 to the open position P2, and thus the foreign matters can be easily removed. Further, the paper guide 5 and the housing 2 are positioned with respect to each other except for a pivot angle, and hence after removal of the foreign matters, the paper guide 5 can be reset at a correct position simply by pivoting the paper guide 5 about the pivot axis to the guide position P1. Accordingly, maintenance can be performed more easily as compared to, for example, a case in which the paper guide 5 is configured to be separable from the housing 2. Further, a reduction in printing accuracy due to misalignment of the paper guide 5 can be suppressed. In addition, the paper guide 5 is less liable to be misaligned, and hence high-precision design can be carried out. Further, as compared to a case in which the paper guide 5 is configured to be separable, there is no need to provide dedicated parts for fixing, and thus an increase in the number of parts can be suppressed.

Accordingly, it is possible to provide the thermal printer 1 that enables maintenance to be performed easily while suppressing an increase in the number of parts and a reduction in printing accuracy.

The pivot axis of the paper guide 5 is coaxial with the platen shaft 31 of the platen roller 3. According to this configuration, the platen shaft 31 of the platen roller 3 can be used as the pivot axis of the paper guide 5, and hence there is no need to provide a new part as the pivot axis. Accordingly, maintainability can be improved while suppressing an increase in the number of parts. In addition, when the platen shaft 31 of the platen roller 3, which is mounted with high positional accuracy, is used as the pivot axis, positional accuracy at the time of mounting the paper guide 5 can also be increased. Accordingly, even when the paper guide 5 is pivoted for maintenance, a reduction in printing accuracy due to pivoting movement of the paper guide 5 can be suppressed.

The paper guide 5 includes the snap-fit portions 53 that are fixed to the housing 2 in the guide position P1. According to this configuration, the paper guide 5 is fixed to the housing 2 when the snap-fit portions 53 of the paper guide 5 are fitted to the housing 2. Accordingly, after the paper guide 5 is pivoted to the open position P2 for maintenance, the paper guide 5 can be easily returned to the originally mounted position. This can further improve maintainability. Further, as compared to a case in which the paper guide 5 is mounted to the housing 2 through use of, for example, a fastening member or other fixing parts, an increase in the number of parts can be suppressed.

The paper guide 5 includes the guide rollers 51 and 52 that feed the sheet 10 between the platen roller 3 and the thermal head 4. According to this configuration, the guide rollers 51 and 52 of the paper guide 5 allow the sheet 10 to be fed more reliably between the platen roller 3 and the thermal head 4 through the sheet passage 11. Thus, the sheet 10 can be effectively fed between the platen roller 3 and the thermal head 4. The guide rollers 51 and 52 are mounted to the paper guide 5, and hence the guide roller portions can also be exposed by pivoting the guide rollers 51 and 52 to the open position P2. Accordingly, even when, for example, scraps of the sheet 10 are caught in the guide rollers 51 and 52, these foreign matters can be easily removed. Accordingly, the maintainability can be improved as compared to the related art in which the guide roller portions cannot be exposed.

The technical scope of the present invention is not limited to the above-mentioned embodiments, and various modifications may be made without departing from the gist of the present invention.

For example, a cover member or the like may be further provided, for example, outside the housing 2, although its illustration is omitted in the above-mentioned embodiment. In this case, the cover member may be provided with an operation portion (not shown) for performing various operations of the thermal printer 1. As an example of the operation portion, a switch or a lamp may be provided.

For example, instead of the protrusions 51a and 52a, there may be provided a convex portion, a claw portion, a surface subjected to surface treatment, or the like on each of the outer peripheral portions of the guide rollers 51 and 52.

In the above-mentioned embodiment, description is given of the configuration in which the sensor 28 for detecting a position of the leading edge of the sheet 10 is provided on the upper wall 23 of the housing 2, but the present invention is not limited to this configuration. A sensor for detecting the position of the leading edge of the sheet 10 may be provided on the lower surface of the paper guide 5.

Besides the above, the components in the above-mentioned embodiments may be replaced by well-known components as appropriate without departing from the gist of the present invention. Further, the above-mentioned embodiments can be combined with each other as appropriate.

What is claimed is:

1. A thermal printer, comprising:
a housing;
a platen roller supported on the housing so as to be rotatable;
a thermal head housed in the housing and arranged so as to be opposed to the platen roller; and
a paper guide that forms a sheet passage for a sheet between the housing and the paper guide, and is pivotally supported on the housing so as to be pivotable about a pivot axis between a guide position at which the sheet is allowed to be fed between the platen roller and the thermal head, and an open position at which the sheet passage for the sheet is exposed.

2. The thermal printer according to claim 1, wherein the pivot axis is coaxial with a platen shaft of the platen roller.

3. The thermal printer according to claim 1, wherein the paper guide includes a snap-fit portion that is fixed to the housing in the guide position.

4. The thermal printer according to claim 1, wherein the paper guide includes a guide roller configured to feed the sheet between the platen roller and the thermal head.
